(19) United States
(12) Patent Application Publication
(10) Pub. No.: US 2004/0204004 A1
(43) Pub. Date: Oct. 14, 2004

(54) Wireless dialing apparatus for mobile phones

(75) Inventor: Tonny Chen, Chang-Hua (TW)

Correspondence Address: BRUCE H. TROXELL, SUITE 1404, 5205 LEESBURG PIKE, FALLS CHURCH, VA, 22041, US

(73) Assignee: E-Lead Electronic Co., Ltd.

(21) Appl. No.: 10/219,342

(22) Filed: Aug. 16, 2002

(51) Int. Cl. H04B 1/38; H04M 1/00

(52) U.S. Cl. 455/550.1; 455/90.1

(57) ABSTRACT

A wireless dialing apparatus for mobile phones mainly includes a dialing device anchored on the rim of a car steering wheel by means of a pliable strap and a receiver located in a handfree handset or in a car stereo device to enable the car driver to dial phone numbers conveniently and safely without holding the handset.

### BACKGROUND OF THE INVENTION

1. Field of the Invention

The invention relates to a wireless dialing apparatus for mobile phones and particularly a wireless dialing apparatus for car drivers to use without jeopardizing driving safety.

2. Description of the Prior Art

With increasing popularity of mobile phones, many peripheral devices of mobile phones have been developed and introduced in the market place. In addition, many laws and regulations have been made and announced that car drivers can use the mobile phones in the car during driving only through handfree handsets. In order to comply with such regulations and to take into account of safety, many peripheral devices for mobile phones also have been developed. Handfree handset is one of the typical examples. However the general handfree handsets provide only simple handfree conversation function, does not offer handfree dialing services. To remedy such a shortcoming, some producers have made improvements as shown in FIG. 1.

It mainly couples an infrared light dialing device 52 on the steering wheel 51 and provides a handfree handset 53 equipped with an infrared light receiver 531. However, the infrared light has a small emission angle, and the distance between the infrared light dialing device 52 and the infrared light receiver 531 is short in the car. In the event that the infrared light of the infrared light dialing device 52 does not directly project on the infrared light receiver 531, the infrared light dialing device 52 cannot function. Moreover, the steering wheel 51 of the car is constantly turned during driving without being set at a stationary position. As a result, the infrared light dialing device 52 often does not directly project on the infrared light receiver 531.

Moreover, conventional infrared light dialing devices have very strict emission and receiving positions due to the constraint of the small emission angle. Hence their practical value is greatly reduced. How to overcome the dead angle of the infrared light is an important issue remains to be resolved.

### SUMMARY OF THE INVENTION

The primary object of the invention is to provide a wireless dialing apparatus for mobile phones that employs reflection of the infrared light to overcome the restrictions of the positions of the infrared light emission and receiving end, and to effectively resolve the dead angle problem.

To attain the foregoing object, the invention mainly includes a dialing device and a receiver coupled with a handfree handset or installed in the car stereo device. The dialing device first projects infrared light towards the body of the driver, and the infrared light reflects from the body of the driver and projects onto the receiver. Thus it effectively overcomes the inaccurate projection problem between the infrared light emitter and the receiver.

The foregoing, as well as additional objects, features and advantages of the invention will be more readily apparent from the following detailed description, which proceeds with reference to the accompanying drawings.

### BRIEF DESCRIPTION OF THE DRAWINGS

FIG.1 is a schematic view of a conventional infrared light handfree handset.

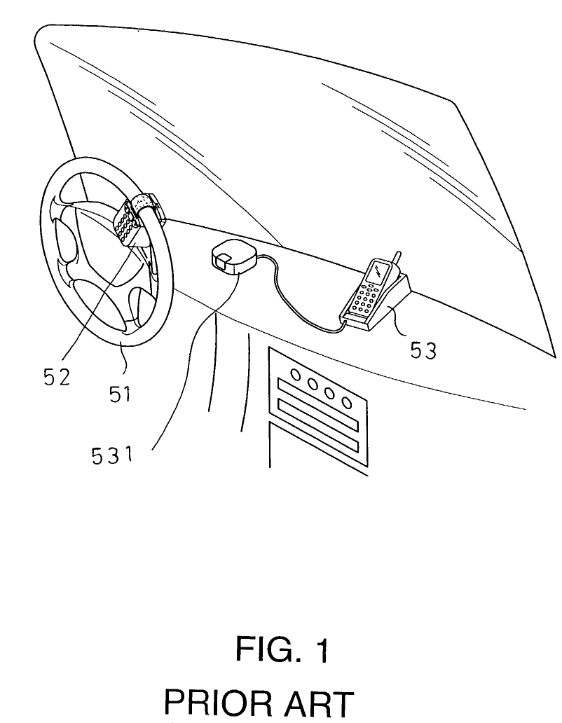

FIG.2 is an exploded view of a first embodiment of the invention.

FIG.3 is a perspective view of the first embodiment the invention.

FIG.4 is a sectional view of the first embodiment of the invention.

FIG.5 is a schematic view of the first embodiment of the invention in use.

FIG.6 is another schematic view of the first embodiment of the invention in use.

FIG.7 is yet another schematic view of the first embodiment of the invention in use.

FIG. 8 is a circuit diagram of the invention.

FIG. 9 is a perspective view of a second embodiment of the invention.

FIG. 10 is a schematic view of a third embodiment of the invention.

### DESCRIPTION OF THE PREFERRED EMBODIMENTS

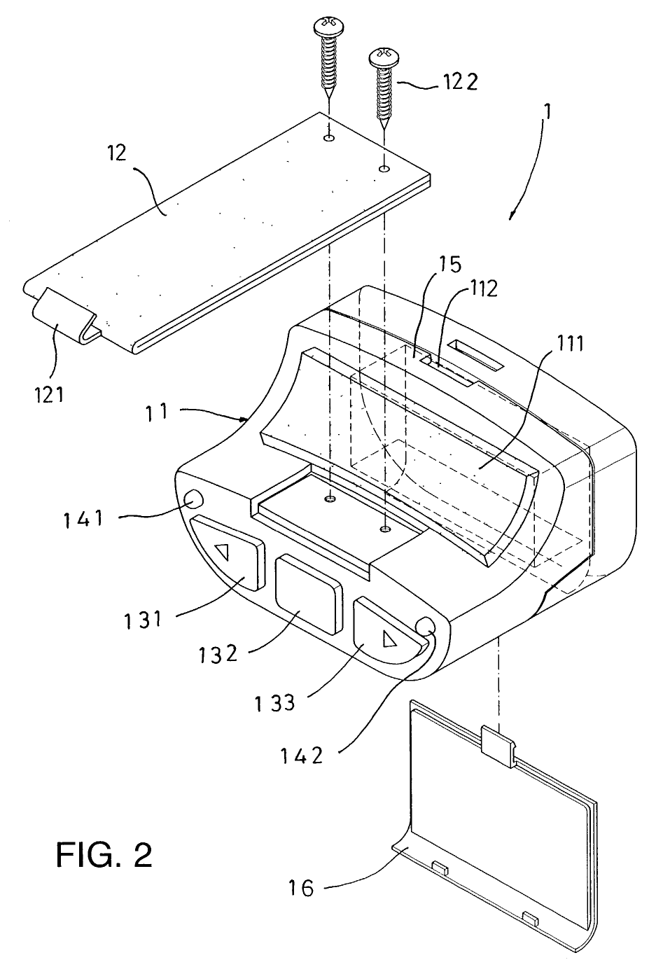

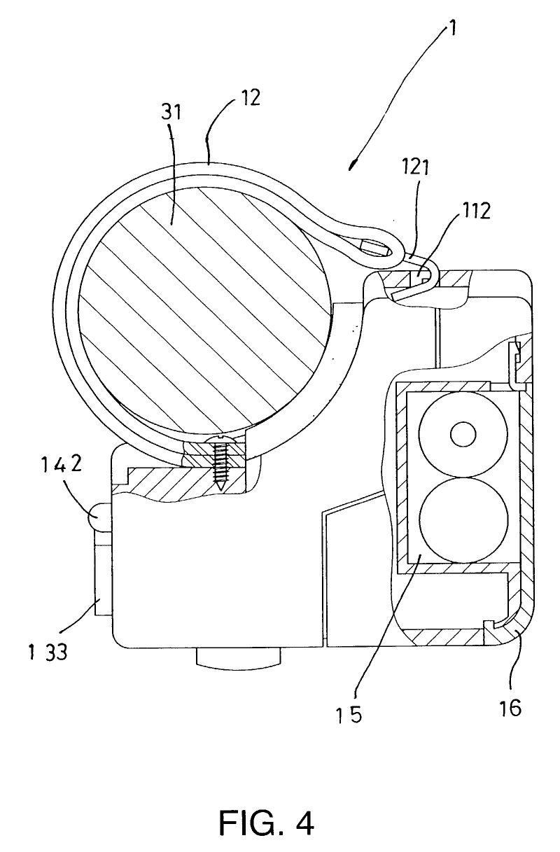

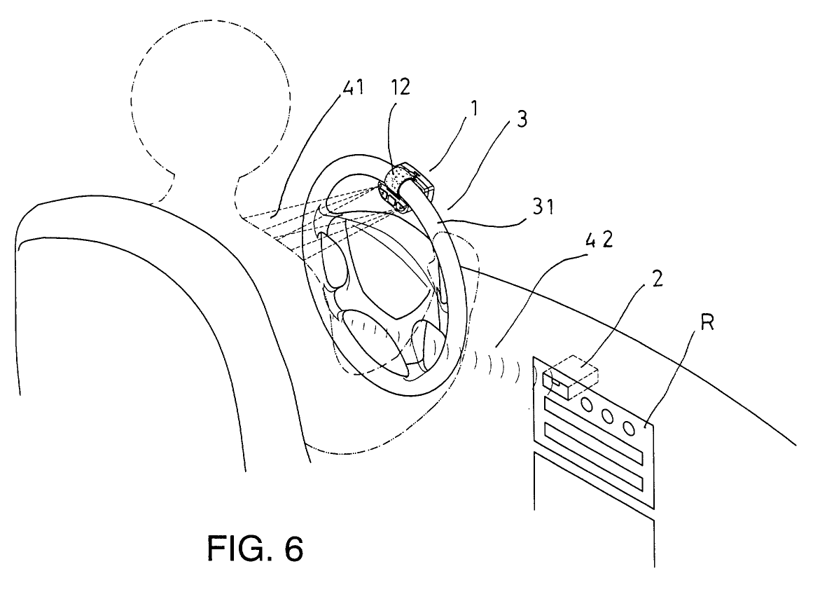

Refer to FIGS. 2 through 6 for a first embodiment of the invention. The wireless dialing apparatus of the invention mainly includes a dialing device 1 and a receiver 2 coupled with a handfree handset H or the car stereo device R.

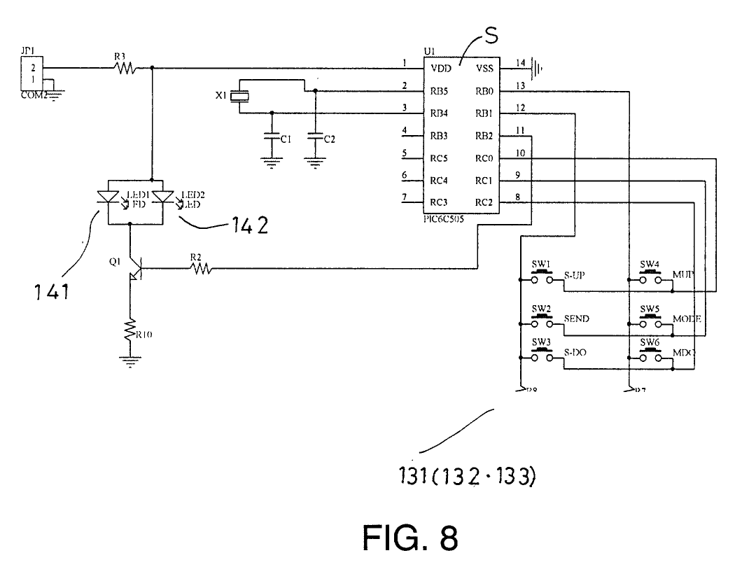

The dialing device 1 has an arched groove 11 to rest on the rim 31 of the car steering wheel 3, and may be fastened to the rim 31 of the steering wheel 3 by means of a pliable strap 12 which has a hook 121 located on one end thereof to engage with a slot 112 located on the upper rim of the arched groove 11. The other end of the strap 12 is fastened to the lower rim of the arched groove 11 by means of fasteners 122. Thus the dialing device 1 may be securely mounted on the car steering wheel 3. On the arched groove 11, there is a soft pad 111. The front side of the dialing device 1 that faces the driver has fast dialing buttons 131, 132 and 133, and infrared light emitters 141 and 142. The dialing device 1 is controlled by a main control IC S (as shown in FIG. 8) to receive or output commands to function. The dialing device 1 further has a battery chamber 15 and a lid 16 for covering.

The receiver 2 can receive the infrared light signals emitted from the dialing device 1 and reflected from the driver. The receiver 2 may be included in the handfree handset H or in the car stereo device R.

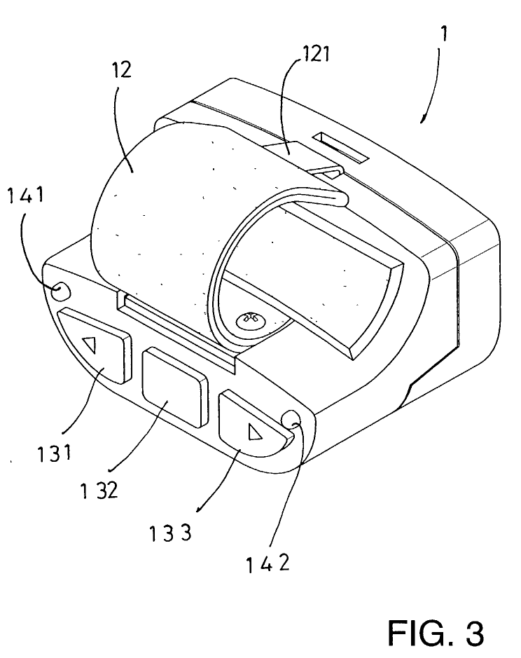

As shown in FIGS. 3 through 6, the apparatus of the invention set forth above may be coupled with a mobile phone P when in use. The dialing device 1 may be anchored on the rim 31 of the steering wheel 3 by means of the strap 12 with the hook 121 located on one end of the strap 12 latching on the slot 112 formed on the upper rim of the arched groove 11 of the dialing device 1. The fast dialing buttons 131, 132 and 133, and the infrared light emitters 141 and 142 face the driver.

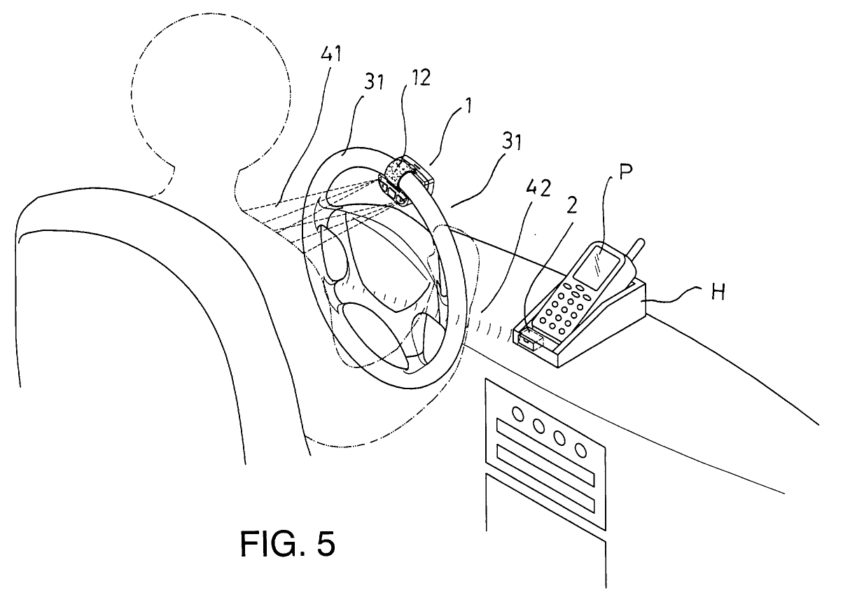

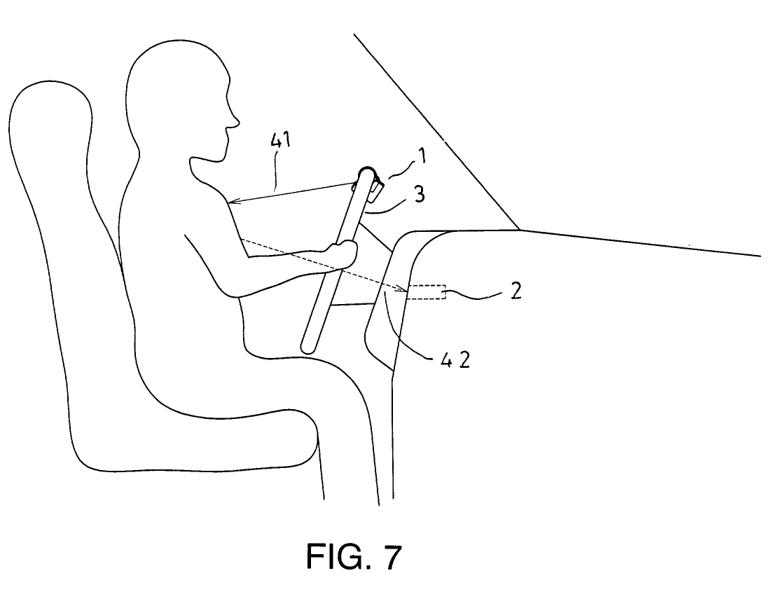

Refer to FIG. 8 for the circuit diagram of the invention. When in use, the driver pushes the fast dialing buttons 131 and 133 to search the required phone number. Once getting the number, the driver pushes another fast dialing button 133 to make confirmation. The dialing device 1 then emits the dialed data through infrared light by means of the infrared light emitters 141 and 142 towards the driver (as shown in FIGS. 5, 6 and 7). The infrared light is reflected from the body of the driver to the receiver 2 to accomplish the dialing function.

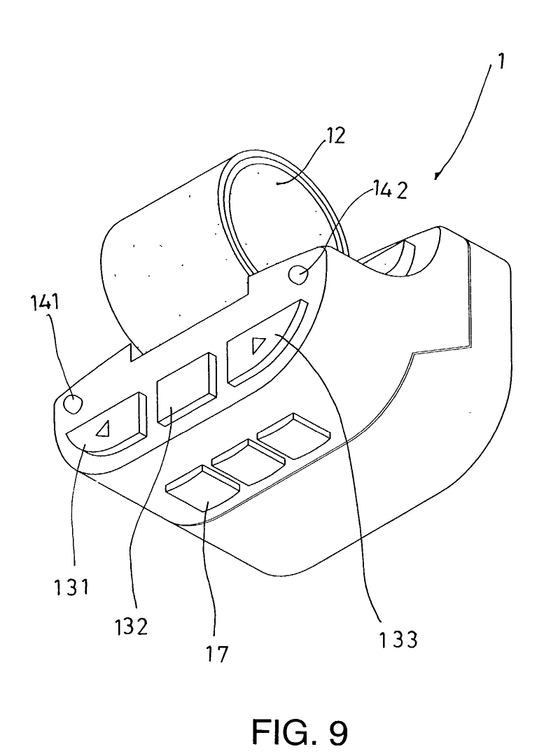

Refer to FIG. 9 for a second embodiment of the invention. In order to facilitate dialing operation for the users, the dialing device 1 may have at least one function key 17 located on a lower side thereof for presetting desired functions or enabling users to set the functions desired.

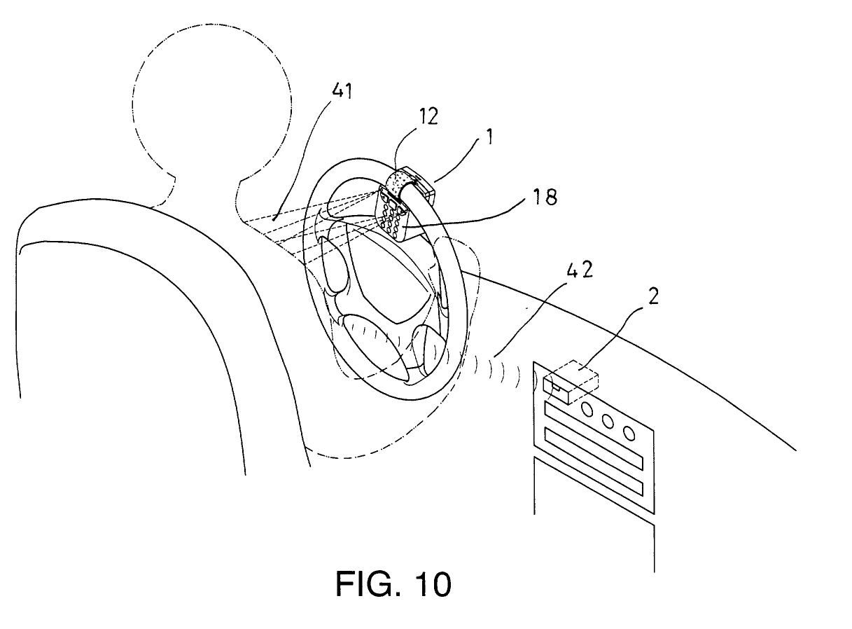

Refer to FIG. 10 for a third embodiment of the invention. The dialing device 1 may also include a number keypad 18 to allow users to directly enter phone numbers. The number keypad 18 may include numerals 0-9 and notations * and # and the like.

By means of the construction set forth above, the invention can effectively resolve the problems of angle restriction related to infrared light emission and receiving, and the dead angle that occur to the conventional infrared light dialing apparatus.

While the preferred embodiments of the invention have been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

I claim:

1. A wireless dialing apparatus for a mobile phone, comprising:
a dialing device anchored on the rim of a steering wheel by means of a pliable strap having at least one fast dialing button and at least one infrared light emitter located on a front side thereof for emitting infrared light signals towards a driver; and
a receiver for receiving the infrared light signals reflecting from the driver.

2. The wireless dialing apparatus of claim 1, wherein the dialing device further includes a battery chamber and a lid for covering the dialing device.

3. The wireless dialing apparatus of claim 1, wherein the dialing device has an arched groove, the pliable strap having one end anchored on an upper rim of the arched groove of the dialing device and other end fastened to a lower rim of the arched groove.

4. The wireless dialing apparatus of claim 3, wherein the pliable trap has a hook fastened to the one end for engaging with a slot formed on the upper rim of the arched groove of the dialing device .

5. The wireless dialing apparatus of claim 3, wherein the pliable trap has the other end fastened to the lower rim of the arched groove of the dialing device by means of fasteners.

6. The wireless dialing apparatus of claim 3, wherein the arched groove of the dialing device has a soft pad located thereon.

7. The wireless dialing apparatus of claim 1, wherein the receiver is located in a handfree handset.

8. The wireless dialing apparatus of claim 1, wherein the receiver is located in a car stereo device.

9. The wireless dialing apparatus of claim 1, wherein the dialing device further has at least one function key located on a lower side thereof.

10. The wireless dialing apparatus of claim 1, wherein the dialing device further includes a number keypad.
